(19) United States
(12) Patent Application Publication
(10) Pub. No.: US 2008/0222005 A1
(43) Pub. Date: Sep. 11, 2008

(54) SYSTEM AND METHOD OF CONTROLLING PROCUREMENT OF SANCTIONED VEHICLE PARTS

(75) Inventor: John Francis SCHICKLER, Rochester, NY (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: FleetCross Holdings, Inc., Rochester, NY (US)

(21) Appl. No.: 12/043,431

(22) Filed: Mar. 6, 2008

Related U.S. Application Data
(60) Provisional application No. 60/905,702, filed on Mar. 8, 2007.

(51) Int. Cl. G06Q 30/00

(52) U.S. Cl. 705/26; 705/1

(57) ABSTRACT

Systems and methods for a procurement system are provided. Additionally, computer-implemented methods for controlling procurement of sanctioned vehicle parts are provided. These methods may include associating one or more sanctioned vehicle parts with a specific vehicle in a fleet using a unique vehicle identification number, receiving a request for information associated with one or more sanctioned vehicle parts for the specific vehicle, and providing one or more sanctioned vehicle parts.

### CROSS REFERENCE TO RELATED APPLICATIONS

This application claims priority to provisional U.S. Application Ser. No. 60/905,702 filed Mar. 8, 2007 entitled “Controlled Procurement System,” which is incorporated by reference herein in its entirety.

### FIELD OF THE INVENTION

This invention relates to management and control of the parts procurement processes engaged in by company repair facilities and shops. More particularly, it provides procurement control in an online parts procurement system, allowing company procurement officers to (among other things) manage, limit and/or control procurement of parts so that only sanctioned parts are procured for repairs and use in company repair facilities and shops.

### BACKGROUND OF THE INVENTION

Company procurement officers negotiate with the officers of parts suppliers for specific terms of supply, such as prices, quantities, discounts, shipping arrangements, choices of part numbers, containerization, billing arrangements, payment terms, etc. The arrangements reached are then communicated to the company's repair facilities and shops to ensure their compliance with company procurement policies, including specific part numbers to be purchased and their sources. However, the company's shops and repair facilities nonetheless often make their own choices of what parts to buy from parts dealers, whether or not they otherwise follow the arrangements arduously pre-negotiated between the company's procurement officers and the officers of the parts suppliers.

### SUMMARY OF THE INVENTION

At least one exemplary embodiment may provide a computer-implemented method for controlling procurement of sanctioned vehicle parts. This embodiment may include associating one or more sanctioned vehicle parts with a specific vehicle in a fleet using a unique vehicle identification number, receiving a request for information associated with one or more sanctioned vehicle parts for the specific vehicle, and providing one or more sanctioned vehicle parts.

Embodiments may also provide a system for controlling procurement of sanctioned vehicle parts. These embodiments may include a database module to associate one or more sanctioned vehicle parts with a specific vehicle in a fleet using a unique vehicle identification number, a vehicle part module to receive a request for information associated with the one or more sanctioned vehicle parts for the specific vehicle, and a purchase order module to provide one or more sanctioned vehicle parts.

Additional embodiments may provide a computer-implemented method for controlling procurement of sanctioned vehicle parts. These embodiments may include establishing a relationship with one or more repair shops, one or more fleet companies, and one or more part supplier vendors, associating one or more sanctioned vehicle parts with a specific vehicle in a fleet using a unique vehicle identification number, receiving a request for information associated with one or more sanctioned vehicle parts for the specific vehicle, and providing one or more sanctioned vehicle parts.

These and other embodiments and advantages of the embodiments of the present invention will become apparent from the following detailed description, taken in conjunction with the accompanying drawings, illustrating by way of example the principles of the invention.

### BRIEF DESCRIPTION OF THE DRAWINGS

The embodiments of the present invention, together with further objects and advantages, may best be understood by reference to the following description taken in conjunction with the accompanying drawings, in the several Figures of which like reference numerals identify like elements, and in which:

FIG. 1a provides a system level block diagram illustrating components of a system for controlling procurement of sanctioned vehicle parts according to at least one embodiment of the disclosure.

FIG. 1b provides a system level block diagram illustrating various components of a procurement system according to at least one embodiment of the disclosure.

FIG. 2 provides, in schematic form, an overview of the operations and features of an embodiment of my invention according to at least one embodiment of the disclosure.

FIG. 3 provides an exemplary screen shot illustrating a database cross-reference table for use by a procurement officer showing a history of part orders and other details according to at least one embodiment of the disclosure.

FIG. 4 provides an exemplary depiction of vehicle part data in a database according to at least one embodiment of the disclosure.

FIG. 5 provides an exemplary screen display of login information according to at least one embodiment of the disclosure.

FIG. 6 provides an exemplary screen shot illustrating an exhaustive listing of possible choices for a part being sought in the form of a cross-reference screen providing part numbers, descriptions, supplier codes and prices for the possible choices for a part number entry according to at least one embodiment of the disclosure.

FIG. 7 provides an exemplary screen shot illustrating an e-procurement screen of the invention, where a part number from the cross reference table provided in FIG. 6 has been posted and possible manufacturers/suppliers are listed according to at least one embodiment of the disclosure.

FIG. 8 provides an exemplary screen shot illustrating the e-procurement screen after the user has clicked on a particular possible manufacturer/supplier, and the system has provided the preferred and sanctioned part and manufacturer according to at least one embodiment of the disclosure.

FIG. 9 provides an exemplary screen shot illustrating the e-procurement screen after the user has clicked on a particular part to be posted to the purchase order, showing only the sanctioned part being copied thereto according to at least one embodiment of the disclosure.

FIG. 10 provides an exemplary screen shot illustrating an electronic purchase order with the order made in FIG. 9 posted thereto according to at least one embodiment of the disclosure.

FIG. 11 provides an exemplary screen shot illustrating an alternate form of drill-down search initiated with entry of a company's “equipment #” for a particular company vehicle, and leading to a particular part number for a brake drum according to at least one embodiment of the disclosure.

FIG. 12 provides an exemplary screen shot illustrating an exhaustive listing of possible choices for the part disclosed as a result of the search of FIG. 11 in the form of a cross-reference screen providing part numbers, descriptions, supplier codes and prices for the possible choices for a part number entry according to at least one embodiment of the disclosure.

FIG. 13 provides an exemplary screen shot illustrating the c-procurement screen initiated as a result of the search of FIGS. 11 and 12 after the user has clicked on the sanctioned part to he posted to the purchase order, showing the sanctioned part being copied thereto according to at least one embodiment of the disclosure.

FIG. 14 provides an exemplary screen shot illustrating the e-procurement screen initiated as a result of the search of FIGS. 11 and 12 after the user has clicked on a non-sanctioned part to be posted to the purchase order, showing the sanctioned part being copied thereto according to at least one embodiment of the disclosure.

FIG. 15 provides a flow chart detailing a procurement system controlling procurement of sanctioned vehicle parts according to at least one embodiment of the disclosure.

### DETAILED DESCRIPTION OF PREFERRED EMBODIMENTS

The following description is intended to convey a thorough understanding of the embodiments described by providing a number of specific embodiments and details involving systems and methods for controlling procurement of sanctioned vehicle parts. It should be appreciated, however, that the embodiments of the present invention are not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

The description below describes elements of a procurement system that may include one or more modules, some of which are explicitly shown in the figures, others that are not. As used herein, the term “module” may be understood to refer to computing software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in multiple devices.

The description below also describes physical and logical elements of a procurement system, some of which are explicitly shown in figures, others that are not. The inclusion of some physical elements of a procurement system may help illustrate how a given system may be modeled. It should be noted, however, that all illustrations are purely exemplary and that the procurement system described herein may be performed on different varieties of systems which may include different physical and logical elements.

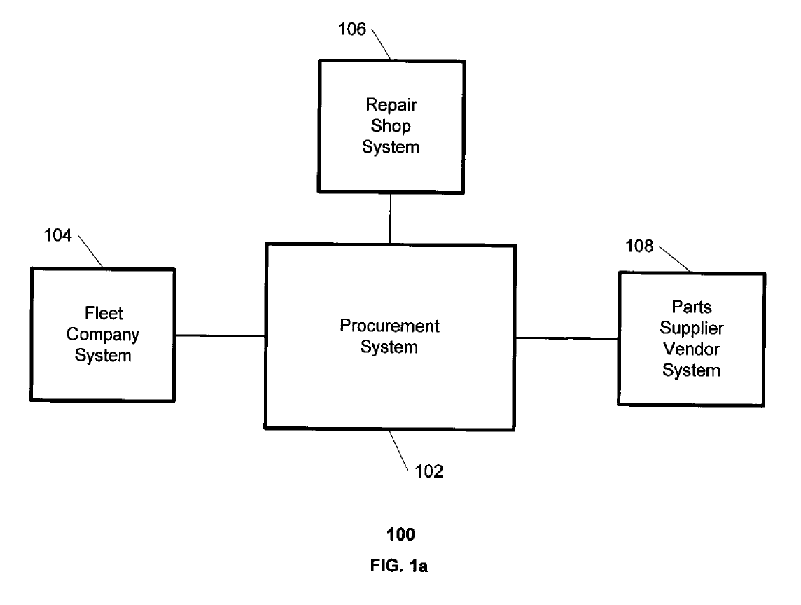

For instance, system 100 from FIG. 1 illustrates a simplified view of a system scheme and various elements associated with a procurement system. It is noted that other hardware and software not depicted may be included in system 100. It is also noted that system 100 illustrates a specific number of instances of repair shop systems, fleet company systems, parts supplier vendor systems, and/or procurement systems. It will be appreciated that a single instance and/or multiple instances of these entities may be included in a system.

It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof.

The frustration of sanctioned procurement processes by the company's shops can he extremely costly to the company. For example, a trucking fleet with multiple shops and vehicles requiring expensive parts replacement can easily suffer many thousands of dollars in losses. In one case, over the course of six months a trucking fleet purchased 104 new TAS65 steering gears designated 14-13452-001 from Freightliner (a parts supplier) at $1,090.54 each for a total of $110,084. However, Freightliner also had available a less expensive sanctioned alternative, the Reman RGT TAS65004R at $487.87 each. Thus, over a six month period, the trucking fleet's shops wasted $59,738 (and would waste $118,692 over the course of a year). Likewise, in another example, a trucking fleet purchased 2,286 brake drums from Freightliner over the course of six months at $86.82 rather than the sanctioned alternative at $76.15. Here, the total loss was $24,826 over the course of six months and would be $49,652 if continued over the course of a year. And, these are just two isolated parts examples. When considering the huge variety and total numbers of parts ordered in a years time by, e.g., a large trucking concern; it is clear that companies can and do sustain massive financial losses merely from the failure of shop personnel to faithfully follow and take advantage of the negotiations and decisions of the company and its officers in terms of parts choices, procurement and use.

The parts procurement arrangements sought by the company and effectuated by pre-negotiated agreements between the company's procurement officers and the officers of the part supplier are ignored (and frustrated) by the company's shops for a variety of reasons. First, the shop may be ignorant of the sanctioned part numbers and prices developed by the company's procurement officers. Second, the shop may be ignorant of alternate choices of part numbers when sanctioned ones are not available. Third, the shop may stubbornly and willfully refuse to change its established or desired patterns for ordering parts from parts suppliers. Fourth, the shop may rely upon the part supplier's indications of acceptable alternatives for sanctioned parts. However, notwithstanding the reasons underlying the failure of shops and repair facilities to follow established procurement procedures, my invention provides a solution for the problem.

In order to practice my invention, it is first necessary to compile (at the minimum) a computer accessible database listing all vehicles (or other items of equipment) for which parts could be required, all parts for each vehicle so listed, possible alternatives for each such part, and the prices for such pars and alternatives. Various other features and information can be added to this database for the convenience of the user. In addition to this database, my controlled procurement system relies on the use of a computer pro-ram for accessing and processing information from the aforesaid database. This program provides (at a minimum) a listing of vehicle parts for a particular vehicle listed in the database when the user indicates a particular vehicle in the database, the alternatives for each such part, and the prices of each such part or alternative. Preferably, and in order to facilitate the operation of my system, a single code number is used in the database to denote each part. This code number is used by the computer program to link all of the aforesaid items of data. In effect, the code provides a single correct definition of a vehicle part for the multiplicity of possible part numbers used by different manufacturers and suppliers in association with that part. The codes which are used are a published industry standard—the VMRS codes (“Vehicle Maintenance Reporting Standards”) as issued by the Technology and Maintenance Council of the American Trucking Associations, Washington DC.

The aforesaid database and program allow the numerous advantages of my invention to be realized. First, they provide procurement officers with initial access to an extensive computerized database of pans choices (including manufacturers) and prices which are all interchanges for each other, taken from a massive central cross reference database that is constantly updated. Second, they organize and present this data in the form of tables of alternatives (with prices) for a particular item, so that the company's procurement officers can determine the “best-buy” alternatives and use these to negotiate terms of supply with various suppliers. Third, they also provide procurement officers with tables of part numbers already purchased and stocked by the company which are duplicates of one another, allowing the procurement officers to obtain a true idea of what parts are actually in stock and available for part replacement of a particular part. Fourth, they provide procurement officers and their affiliated shops with an electronic cross referencing system in which the sanctioned parts are flagged for the shops. Fifth, they provide the shops with an electronic parts ordering system in which any part they choose from the cross reference will result in their ordering only the parts sanctioned by the procurement officers. Sixth, they provide the shops with an electronic means of placing purchase orders with sanctioned vendors under the terms pre-negotiated by the procurement officers. Seventh, they provide shops with a means of ordering unsanctioned parts, if necessary, but being recorded and identified when they do so. Eighth, they provide procurement officers with a system for determining specific purchasers in the shops who do not comply with the usage of sanctioned parts and sources.

A fleet company may be associated with one or more repair shops that may be operable to perform maintenance tasks as necessary on vehicles associated with the fleet. To ensure that each repair shop is using cost effective vehicle parts in making vehicle repairs, a fleet company may pre-negotiate discount prices with one or more part suppliers for exact vehicle replacement parts and/or alternative vehicle replacement parts. In addition, a fleet company may interact with a procurement system to ensure that each repair shop takes advantage of the prep negotiated discount priced vehicle parts when making repairs in a variety of instances.

A procurement system may interact with one or more fleet companies, one or more vehicle operators associated with one or more fleet companies, one or more vehicle repair shops associated with one or more fleet companies, one or more parts suppliers, and/or one or more parts supplier vendors to control the procurement of one or more sanctioned vehicle parts on behalf of one or more fleet companies. The procurement system may function as a host system to interact with one or more fleet companies, one or more vehicle repair shops, one or more parts suppliers, and/or one or more parts supplier vendors. For example, the procurement system may function to manage and control the procurement of sanctioned vehicle parts process by receiving sanctioned vehicle part information as input from one or more of these entities and outputting sanctioned vehicle part information to one or more of the entities.

In exemplary embodiments, the procurement system may be configured to receive as input vehicle part information associated with a specific vehicle of a fleet. Vehicle part information may be associated with a vehicle identification number (“VIN”) and/or any other identifier that may be used to identify the specific vehicle of the fleet and/or one or more sanctioned vehicle parts for the specific vehicle of the fleet. For example, the VIN “2T1FF28PX1C539497” may be associated with a specific heavy duty truck made by the Volvo corporation. Using the VIN “2T1FF28PX1C539497” as a unique identifier, the procurement system may be configured such that various sanctioned vehicle parts associated with the Volvo heavy duty truck is associated with the VIN “2T1FF28PX1C539497.” A sanctioned vehicle part may include an exact vehicle part and/or an alternative vehicle part that is associated with a pre-negotiated price (e.g., discount price, etc.). An exact vehicle part may include a vehicle part that may match an inoperable vehicle part that may be replaced in manufacture and model. An alternative vehicle part may include a vehicle part that may not match an inoperable vehicle part that may be replaced in manufacture and model, but may be considered a properly functioning substitute to the exact vehicle part. In various embodiments, a non-sanctioned vehicle part may include an exact vehicle part and/or alternative vehicle part that is not associated with a pre-negotiated price.

Accordingly, the procurement system may be configured to receive pre-negotiated price data associated with one or more exact vehicle parts and/or one or more alternative vehicle parts from a fleet company and/or a pars supplier. For example, instead of being required to pay the full price of $1,000.00 for a truck tire made by ABC Corporation for a medium duty truck, a fleet company may pre-negotiate with a parts supplier to pay $850.00 for an exact replacement truck tire (e.g., a truck tire of the same make and model as the original truck tire) or $750.00 for an alternative replacement truck tire (e.g., a truck tire that is not the same make and model as the original truck tire, but operatively equivalent). Accordingly, the fleet company may designate the discounted truck tires as sanctioned vehicle parts for a specific vehicle in the fleet (e.g., the medium duty truck in the previous example) in the procurement system and the procurement system may associate the sanctioned vehicle parts with the specific vehicle using a VIN.

In exemplary embodiments, the procurement system may be configured to periodically associate vehicle part inventory data from one or more parts supplier vendors and/or one or more parts suppliers with one or more sanctioned vehicle parts. Accordingly, the procurement system may be configured to output and/or display the availability of one or more sanctioned vehicle parts at one or more parts supplier vendor systems. For example, a parts supplier vendor, ACME Company, may be an established supplier of discounted sanctioned vehicle parts for a fleet company. As ACME Company's inventory changes, the ACME Company may input inventory data to the procurement system and the procurement system may associate the inventory data with one or more sanctioned vehicle parts. For example, in the month of January, the procurement system may indicate that the ACME Company may have three ABC Corp. XYZ123 transmissions available. However, in that same month, the ACME Company may sell one ABC Corp. XYZ123 transmission. Accordingly, the ACME Company may input updated inventory data in the procurement system and the procurement system may associate the updated inventory data with all entries listing the ABC Corp. XYZ123 transmission as a sanctioned vehicle part.

In various embodiments, inventory data may include a current snapshot of one or more vehicle parts available at one or more parts supplier vendors. Inventory data may also include vehicle part information associated with one or more of the vehicle parts included in the inventory data. For example, vehicle part information may include a unique vehicle parts identification number, manufacturer information, model information, alternative vehicle part information, price information, and/or any other information that may be used to classify a vehicle part.

To locate a sanctioned replacement vehicle part for a specific vehicle in a fleet in accordance with the procurement policies of a fleet company, a repair shop using a graphical user interface associated with a repair shop system may search the procurement system for sanctioned vehicle parts associated with the specific vehicle using the VIN of the specific vehicle. Based on the VA, the procurement system may output and/or display vehicle parts associated with the specific vehicle and one or more sanctioned vehicle parts associated with each vehicle part. For example, a repair shop associated with a fleet company may need to replace a engine in an International Company heavy duty truck associated with the fleet having a VIN of “2T1FFFFF3333333BB.” Using the VIN as input, the repair shop may query the procurement system. The repair shop may then view one or more vehicle parts associated with the heavy duty truck along with one or more associated sanctioned vehicle parts. Accordingly, the repair shop may locate the engine listing for the heavy duty truck and may view information associated with one or more sanctioned engine replacement parts. The repair shop may find two sanctioned replacement engines. The first entry for a sanctioned replacement engine may list a JJJYYY123 engine made by the XYZ corp. for $4,350.45. The second entry for a sanctioned replacement engine may list a 789012 engine made by the ABC corp. for $3,975.00. In the interest of saving money, the repair shop may determine to purchase the 789012 engine on behalf of the fleet company. In exemplary embodiments, the procurement system may be configured to notify a fleet company if one or more repair shops associated with the fleet company has ordered a non-sanctioned vehicle part.

FIG. 1a provides a system level block diagram illustrating components of a system 100 for controlling procurement of sanctioned vehicle parts according to at least one embodiment of the disclosure. Exemplary system 100 may include a fleet company system 104, a repair shop system 106, a parts supplier vendor system 108, and/or a procurement system 102.

It should be noted that the procurement system 102 may be communicatively coupled to and/or reside in a fleet company system 104, a repair shop system 106, and/or a parts supplier vendor system 108. It should also be noted that a fleet company system 104, a repair shop system 106, and/or a pas supplier vendor system 108 may also be communicatively coupled to each other. In various embodiments, the system 100 may also be in communication with a network (not shown). A network may include an analog telephone network, a digital telephone network, a cellular telephone network, a public wide area network (“WAN”), such as the Internet, or, different connections, such as combinations of public and private WANs, local areas networks (“LANs”), wireless LANs, encrypted networks, body area networks, or other wired or wireless networks. A network may also include one, or any number of the exemplary types of networks mentioned above operating as a stand-alone network or in cooperation with each other. Use of the term network herein is not intended to limit the network to a single network.

A fleet company may interact with procurement system 102 using, for example, a fleet company system 104. A fleet company may include a company that maintains one or more vehicles for the purpose of doing business. A fleet company system 104 may include, but is not limited to: e.g., any computer device, or communications device including, e.g., a personal computer (PC), a workstation, a mobile device, a phone, a handheld PC, a personal digital assistant (PDA), a thin system, a fat system, network appliance, an Internet browser, a paging device, an alert device, a television, an interactive television, a receiver, a tuner, a high definition (HD) television, an HD receiver, a video-on-demand (VOD) system, a server, or other device. In various embodiments, a fleet company system 104 may also include an interface to display information received from procurement system 102.

Those of ordinary skill in the art will appreciate that a plurality of potential fleet company systems 104 may be used by one or more fleet companies to input, access, and/or modify data. For example, the fleet company system 104 may be associated with a network, such as the Internet, and fleet company system 104 may interact with procurement system 102 to input, access, and/or modify data via a web browser client installed on the feet company system 104, such as INTERNET EXPLORER, NAVIGATOR, or FIREFOX web browser programs, offered by Microsoft Corporation of Redmond, Wash., Time Warner of New York, N.Y., and the Mozilla Foundation of Mountain View, Calif., respectively.

A repair shop associated with a fleet company may interact with the procurement system 102 using, for example, a repair shop system 106. A repair shop may include a shop that performs maintenance tasks on one or more vehicles associated with a fleet company. Repair shop system 106 may be in communication with procurement system 102. Repair shop system 106 may include, but is not limited to: e.g., any computer device, or communications device including, e.g., a personal computer (PC), a workstation, a mobile device, a phone, a handheld PC, a personal digital assistant (PDA), a thin system, a fat system, network appliance, an Internet browser, a paging, an alert device, a television, an interactive television, a receiver, a tuner, a high definition (HD) television, an HD receiver, a video-on-demand (VOD) system, a server, or other device. In various embodiments, repair shop system 106 may also include an interface to access information received from procurement system 102.

Those of ordinary skill in the art will appreciate that a plurality of potential repair shop systems 106 may be used by one or more repair shops to access, input, and/or modify data. For example, the repair shop system 106 may be associated with a network, such as the Internet, and the repair shop system 106 may interact with procurement system 102 to access, input, and/or modify data via a web browser client installed on the repair shop system 106, such as INTERNET EXPLORER, NAVIGATOR, or FIREFOX web browser programs, offered by Microsoft Corporation of Redmond, Wash., Time Warner of New York, N.Y., and the Mozilla Foundation of Mountain View, Calif., respectively.

A parts supplier vendors may interact with procurement system 102 using, for example, a parts supplier vendor systems 108. A parts supplier vendor may include a vendor that distributes vehicle parts on behalf of a parts supplier. A parts supplier vendor system 108 may be in communication with a procurement system 102. A parts supplier vendor system 108 may include, but is not limited to: e.g., any computer device, or communications device including, e.g., a personal computer (PC), a workstation, a mobile device, a phone, a handheld PC, a personal digital assistant (PDA), a thin system, a fat system, network appliance, an Internet browser, a paging, an alert device, a television, an interactive television, a receiver, a tuner, a high definition (HD) television, an HD receiver, a video-on-demand (VOD) system, a server, or other device. In various embodiments, a parts supplier vendor system 108 may also include an interface to access information received from procurement system 102.

Those of ordinary skill in the art will appreciate that a plurality of potential parts supplier vendor systems 108 may be used by one or more parts supplier vendors to access, input, and/or modify data. For example, the parts supplier vendor system 108 may be associated with a network, such as the Internet, and may interact with procurement system 102 to access, input, and/or modify data via a web browser client installed on the parts supplier vendor system 108, such as INTERNET EXPLORER, NAVIGATOR, or FIREFOX web browser programs, offered by Microsoft Corporation of Redmond, Wash., Time Warner of New York, N.Y., and the Mozilla Foundation of Mountain View, Calif., respectively.

FIG. 1b provides a system level block diagram illustrating various components of a procurement system 102 according to at least one embodiment of the disclosure. As shown in FIG. 1b, a procurement system 102 may include one or more of the following modules: a database module 150, an authentication module 160, a sanctioned vehicle part module 165, a purchase order module 170, an interface module 175, and a communication module 180. Database module 150, authentication module 160, sanctioned vehicle part module 165, purchase order module 170, interface module 175, and communication module may communicate with some or all of the modules of procurement system 102. The modules of procurement system 102 may be part of a single system, or the modules may be physically or logically separated. In various embodiments, procurement system 102 may be operably connected to a network so that the modules of procurement system 102 may receive signals from a network and generate signals to a network.

Authentication module 160 may include software and/or hardware configured to receive authentication information to authenticate users of the procurement system 102. In various embodiments, the authentication information may be received as encrypted ciphertext and decrypted according to protocols well known in the arts In various embodiments, authentication information may include a unique account number, a password, a telephone number, an address, and/or an email address.

For example, an individual associated with a fleet company may create a user account using a fleet company system associated with an interface such as a web browser, to input information associated with the user such as the user's name, the user's telephone number, the user's address, and/or the user's email address into the procurement system 102. A fleet company system may transmit information associated with the user to procurement system 102. Upon receiving information associated with the user, procurement system 102 may assign a unique user account number to that particular user and store information associated with the user in a user account. If, for example, a user is a returning user, the user may transmit a unique user account number to procurement system 102 using a fleet company system. In various embodiments, individuals associated with one or more fleet companies, one or more repair shops, and/or one or more parts supplier vendors may create unique user accounts with procurement system 102.

To authenticate a user, authentication module 160 may have access to a plurality of authentication information associated with one or more users. In an exemplary embodiment, authentication module 160 may store data regarding a plurality of users and their related account authentication information in a database. Authentication module 160 may be coupled to a database such that authentication module 160 may access the database through database module 150.

In various embodiments, authentication module 160 may attempt to match the authentication information to a record that may be stored within and/or associated with procurement system 102. For example, authentication module 160 may attempt to match the authentication information to a record by comparing the authentication information to data within a plurality of records. Upon receiving authentication information that authentication module 160 is not able to verify (e.g., match to a previously stored record, etc.), authentication module 160 may transmit a login authentication error to the user.

Sanctioned vehicle part module 165 may include software and/or hardware configured to associate one or more sanctioned vehicle parts with one or more VINs. For example, the sanctioned vehicle part module 165 may associate the VIN “2T1FF28PX1C539497” with a specific heavy duty truck made by the Volvo corporation. Using the VIN “2T1FF28PX1C539497” as a unique identifier, the sanctioned vehicle part module 165 may be configured to associate all sanctioned vehicle parts pertaining to the Volvo heavy duty truck with the Volvo heavy duty truck using the unique VIN “2T1FF28PX1C539497.”

In various embodiments, the sanctioned vehicle part module 165 may also he configured to associate pre-negotiated price data with one or more sanctioned vehicle parts. Accordingly, the sanctioned vehicle part module 165 may be configured to receive pre-negotiated price data associated with one or more exact vehicle parts and/or one or more alternative vehicle parts from a fleet company and/or a parts supplier. For example, instead of being required to pay the full price of $1,000.00 for a truck tire made by ABC Corporation for a medium duty truck, a fleet company may pre-negotiate with a parts supplier to pay $850.00 for an exact replacement truck tire (e.g., a truck tire of the same make and model as the original truck tire) or $750.00 for an alternative replacement truck tire (e.g., a truck tire that is not the same make and model as the original truck tire, but operatively equivalent). The fleet company may designate the discounted truck tires as sanctioned vehicle parts for a specific vehicle in the fleet (e.g., the medium duty truck in the previous example). Accordingly, the sanctioned vehicle part module 165 may associate the pre-negotiated prices with one or more sanctioned vehicle parts in the procurement system 102 and may further associate one or more sanctioned vehicle parts (along with the pre-negotiated prices) with the specific vehicle using a unique VAN.

In various embodiments, the sanctioned vehicle part module 165 may be configured to associate inventory data received periodically from one or more parts supplier vendors with one or more sanctioned vehicle parts and/or one or more specific vehicles using one or more unique VINs. Accordingly, the sanctioned vehicle part module 165 may be configured to periodically receive vehicle part inventory data from one or more parts supplier vendors as input. Inventory data may include a current snapshot of one or more vehicle parts available at one or more parts supplier vendors. Inventory data may also include vehicle part information associated with one or more vehicle parts included in the inventory data. For example, vehicle part information may include a unique vehicle part identification number, manufacturer information, model information, alternative vehicle part information, price information, and/or any other information that may be used to classify a vehicle part.

By way of a non-limiting example, a repair shop associated with a fleet company may need to replace a engine in an International Company heavy duty truck associated with the fleet having a VIN of “2T1FFFFF3333333BB.” Using the VIN as input, the repair shop may query the sanctioned vehicle part module 165. The sanctioned vehicle part module 165 may then output and/or display one or more vehicle parts associated with the heavy duty truck along with one or more associated sanctioned vehicle parts to the repair shop system. Accordingly, the repair shop may locate the engine listing for the heavy duty truck and may view information associated with one or more sanctioned engine replacement parts. The repair shop may find two sanctioned replacement engines. The first entry for a sanctioned replacement engine may list a JJJYYY123 engine made by the XYZ corp. for $4,350.45. The second entry for a sanctioned replacement engine may list a 789012 engine made by the ABC corp. for $3,975.00. In the interest of saving money, the repair shop may determine to purchase the 789012 engine on behalf of the fleet company. In various embodiments, sanctioned vehicle part module 165 may be configured to output one or more non-sanctioned replacement transmissions. For example, sanctioned vehicle part module 165 may be configured to output one or more non-sanctioned vehicle parts if one or more sanctioned vehicle parts are not available. In another example, sanctioned vehicle part module 165 may be configured to output one or more non-sanctioned vehicle parts if a user has been pre-authorized to do order one or more non-sanctioned vehicle parts. In yet another example, sanctioned vehicle part module 165 may be configured to output one or more non-sanctioned vehicle parts in response to a query for one or more replacement vehicle parts.

Sanctioned vehicle part module 165 may transmit a graphical representation of the vehicle parts information to interface module 175 to enable transmission and subsequent display of the vehicle parts information to the repair shop via the repair shop system.

Interface module 175 may transmit the outputs from the modules associated with procurement system 102 in a form that individuals associated with a fleet company, a repair shop, and/or a parts supplier vendor may perceive using, for example, a fleet company system, a repair shop system, and/or a parts supplier vendor system, respectively. In various embodiments, interface module 175 may be a web server to organize and display information viewable on software installed on a fleet company system, a repair shop system, and/or a parts supplier vendor system.

Purchase order module 170 may include software and/or hardware configured to receive purchase order data from one or more repair shop systems as input. Purchase order data may include one or more purchase requests for one or more vehicle replacement parts. In various embodiments, a vehicle replacement part may include one or more sanctioned vehicle parts and/or one or more non-sanctioned vehicle parts. If, for example, a purchase request includes one or more sanctioned vehicle parts, purchase order module 170 may be configured to transmit the purchase request to one or more parts supplier vendor systems. Purchase order module 170 may also be configured to transmit the purchase request to the fleet company system associated with the specific vehicle being repaired for record keeping purposes. If, however, a purchase request includes one or more non-sanctioned vehicle pans, purchase order module 170 may be configured to transmit a non-sanctioned vehicle part notification to the associated fleet company system and wait for authorization to transmit the purchase request to one or more parts supplier vendor systems from the fleet company system. In various embodiments, purchase order module 170 may be configured to transmit the purchase request associated with one or more non-sanctioned vehicle parts to one or more parts supplier vendor system without authorization from the associated fleet company system.

Procurement system 102 may also include a communication module 180 operable to communicatively connect the various modules of procurement system 102 to each other and/or systems external to the procurement system 102.

Procurement system 102 may also include database module 150 operable to access and store various information in a database. Database module 150 may include any device for accessing and storing various information in a database. In various embodiments, a database may store data, such as, authentication data, regarding one or more individuals associated with a fleet company, a repair shop, and/or a parts supplier vendor. A database may also store any data associated with the procurement system 102. Authentication module 160, sanctioned vehicle part module 165, purchase order module 170, interface module 175, and communication module 180 may be coupled to the database such that authentication module 160, sanctioned vehicle part module 165, purchase order module 170, interface module 175, and communication module 180 may access the database through database module 150 to store and retrieve data as needed.

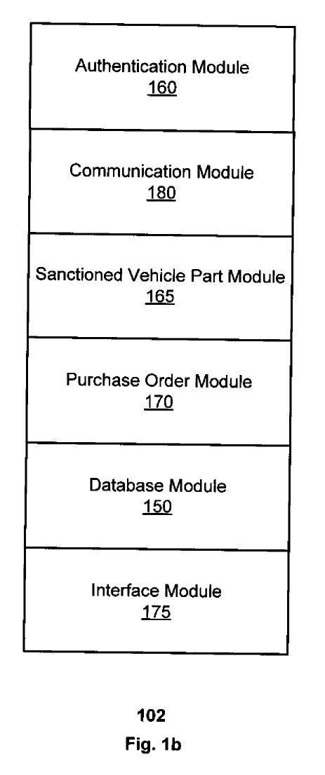

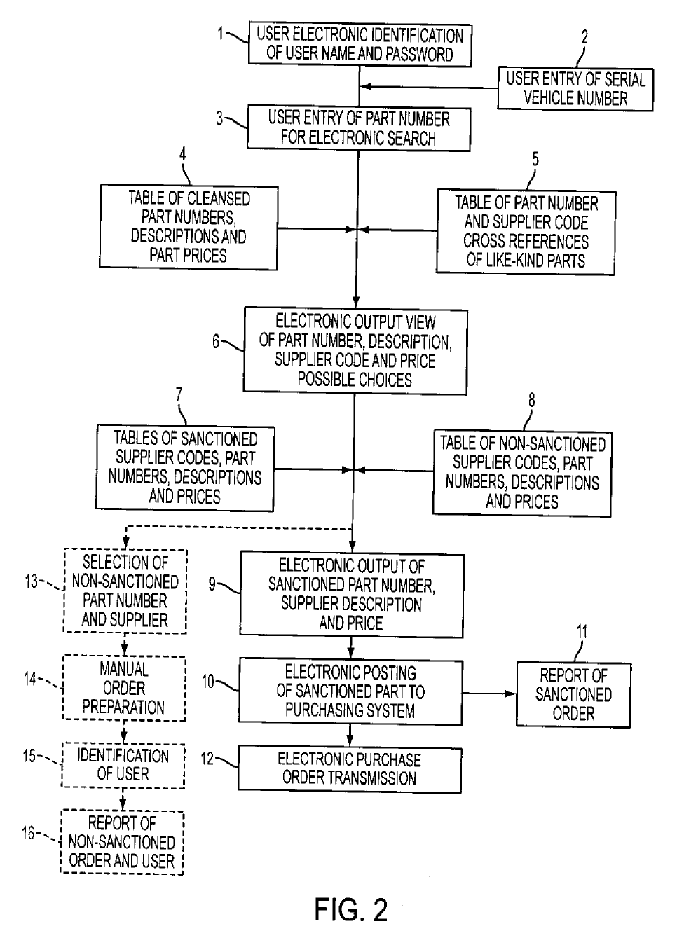

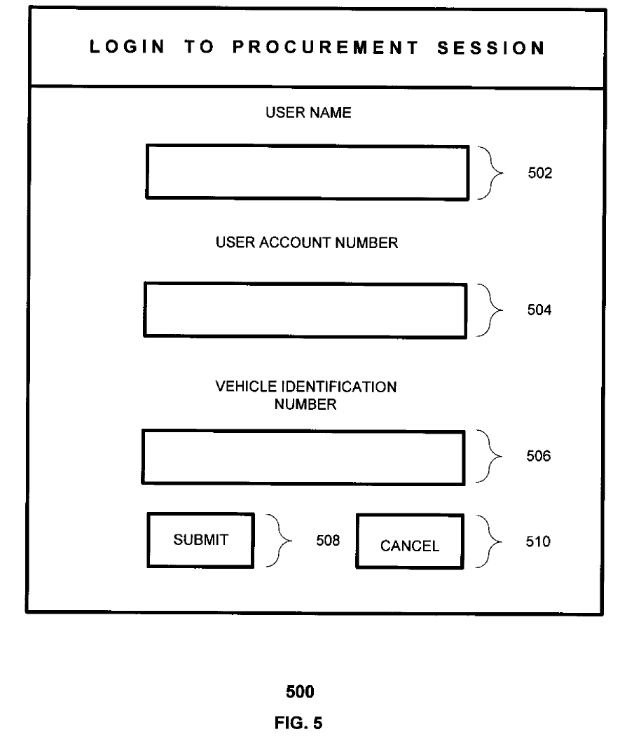

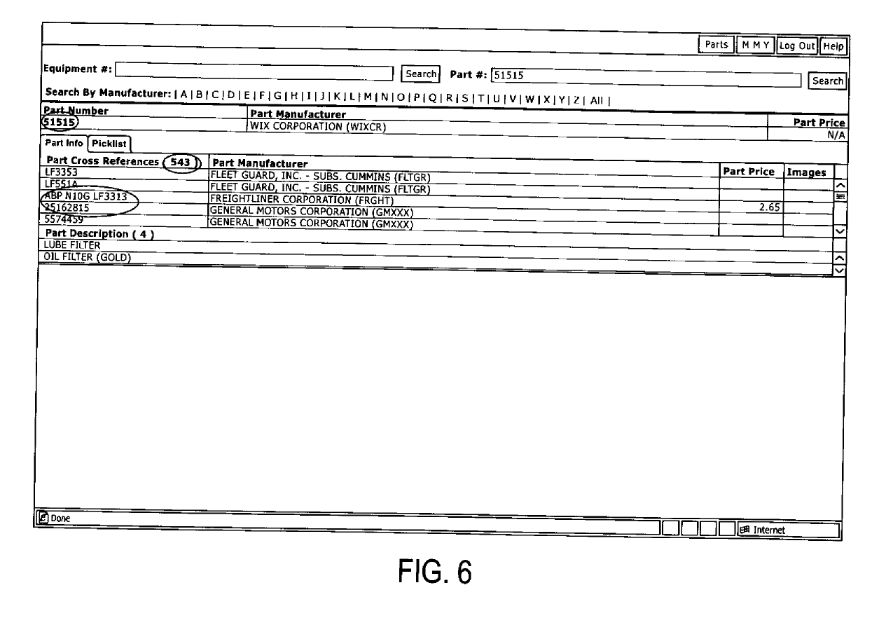

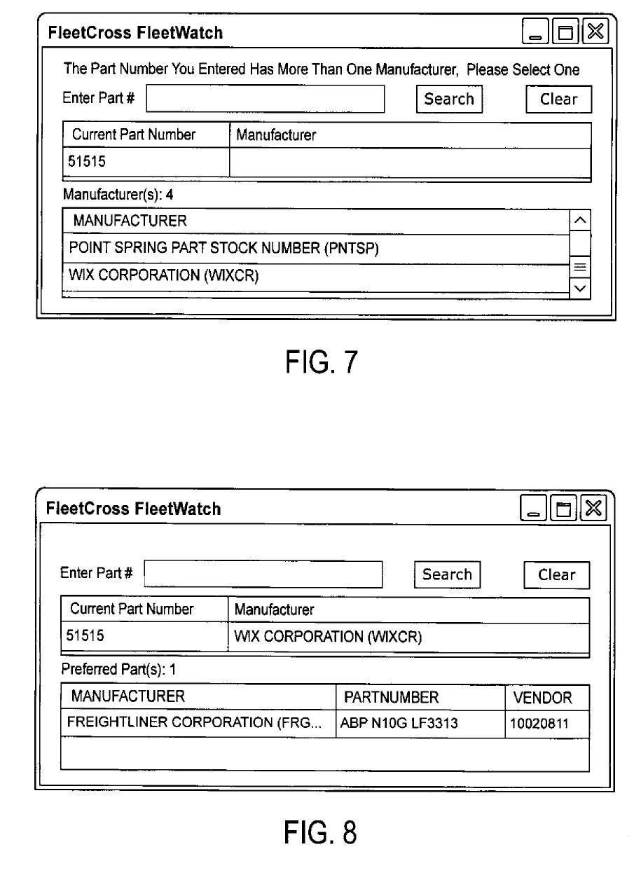

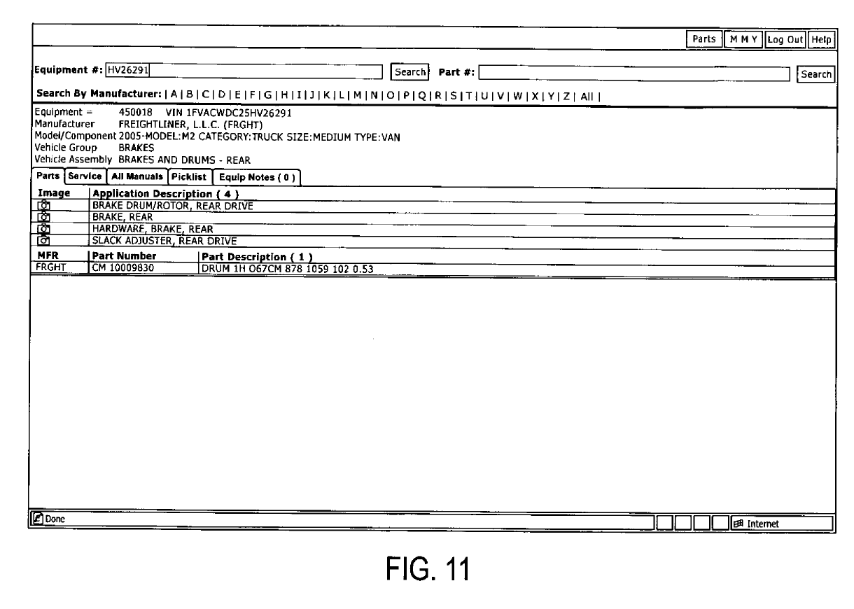

FIG. 3 provides an overview of the operations of a basic embodiment of my invention. As is typical the initial requirement is an authorization function I requiring entry of an electronic identification of user name and password in order to access the system of the invention. From here the next step will depend on whether the user already has the requisite part number. As will be noted from FIGS. 6 and 11, the system of my invention also allows a search to be initiated by use of an equipment number (for the vehicle) or a part manufacturer's name. These alternative search initiators 2 would only be used, generally speaking, if the part number is not known, (The search drill-down used for these alternative search initiations leads ultimately to a part number). Thus, whether an alternative search initiator is used first or not, the next step is to make a part number entry 3 for electronic search. The system of my invention will then access the table of cleansed part numbers 4 as well as the table of like kind parts 5 in order to provide the user with an exhaustive listing of possible choices for the part in the form of a cross-reference screen 6, an electronic output view of part numbers, descriptions, supplier codes and prices for the possible choices for the part number entry 3. (See, e.g., FIG. 6). From this point, as described in more detail with reference to FIGS. 2-3 and 6-14, the system of my invention can access a table of sanctioned parts 7 (including sanctioned supplier codes, part numbers and suppliers) and a table of non-sanctioned parts 8 (including non-sanctioned supplier codes, part numbers and suppliers) to provide the user with a procurement screen 9, an electronic output view of the sanctioned part number, description, supplier code and price for the sanctioned choice for the part number entry 3. (See, e.g., FIGS. 7-8). From here, the sanctioned number can be electronically posted 10 to the purchasing system with reporting of the sanctioned order 1 I to the procurement office of the company. And, finally, the sanctioned order can be transmitted as an electronic purchase order 12. (The aforesaid steps and processes are further described and explicated in the figures that follow).

Alternately, as further illustrated in FIG. 1, since my system requires and allows only the posting of sanctioned parts to a purchase order for electronic ordering, the selection of a non-sanctioned part number and supplier must take place outside of the resources provided by my system, with manual order preparation 14 including identification 15 of the user and reporting of the non-sanctioned order and user to the procurement office of the company 16. This allows the procurement office to speedily and effectively follow up on non-sanctioned orders and shops/individuals that seek to effectuate such non-sanctioned orders (particularly those that habitually or regularly do so).

FIG. 3 provides a screen shot showing a database cross reference table prepared for 20 the procurement officer as part of the data cleansing process. The columns of pan numbers and descriptions on the left are a history of orders 2A, 2B placed by the shops from a multiplicity of unidentified sources. In the middle, the true part numbers 2C and their sources 2D are identified. The sources 2D are coded with a five character alpha schema. Note that the cross referencing of the raw data reveals that the two filters named are actually the same part and are therefore, duplicate inventory. Then, on the right, the parts are cross-referenced to the sanctioned supplier codes 2E, which is once again presented in a 5 character schema (e.g., FRGHT=Freightliner), and the sanctioned part numbers 2F.

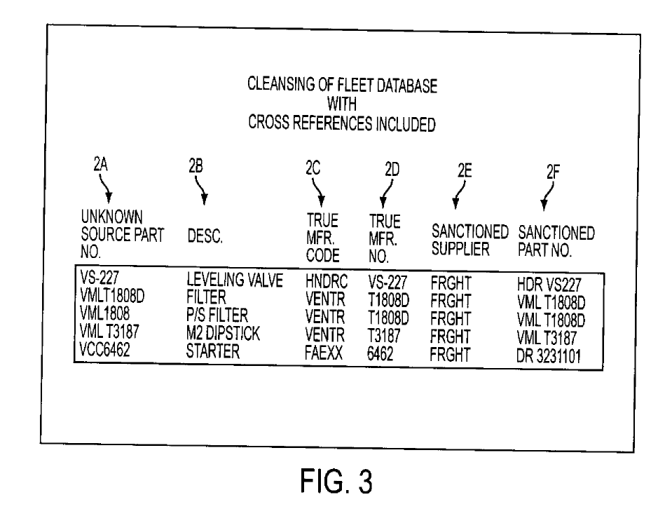

FIG. 4 provides an exemplary depiction of vehicle part data in a database according to at least one embodiment of the disclosure. As discussed above, a database may be configured to associate one or more vehicle parts of a specific vehicle with one or more sanctioned vehicle parts using one a unique VIN associated with the specific vehicle. By way of a non-limiting example, data may be stored in the database as depicted in FIG. 4. As is shown, a database may use a unique VIN 402 to associate the unique VIN 402 with one or more vehicle parts 404 and/or with one or more sanctioned vehicle parts 406 for one or more vehicle parts 404.

For example, if the procurement system receives an inputted VIN of “2T1FF28PX1C539447,” the procurement system may display one or more vehicle parts 404, along with one or more associated sanctioned vehicle parts 406. Accordingly, an individual associated with a repair shop may use the procurement system to search for vehicle parts of a specific vehicle using the unique VIN associated with the specific vehicle. Further, the individual may use the procurement system to search for one or more sanctioned vehicle parts of a specific vehicle using a unique VIN associated with the specific vehicle.

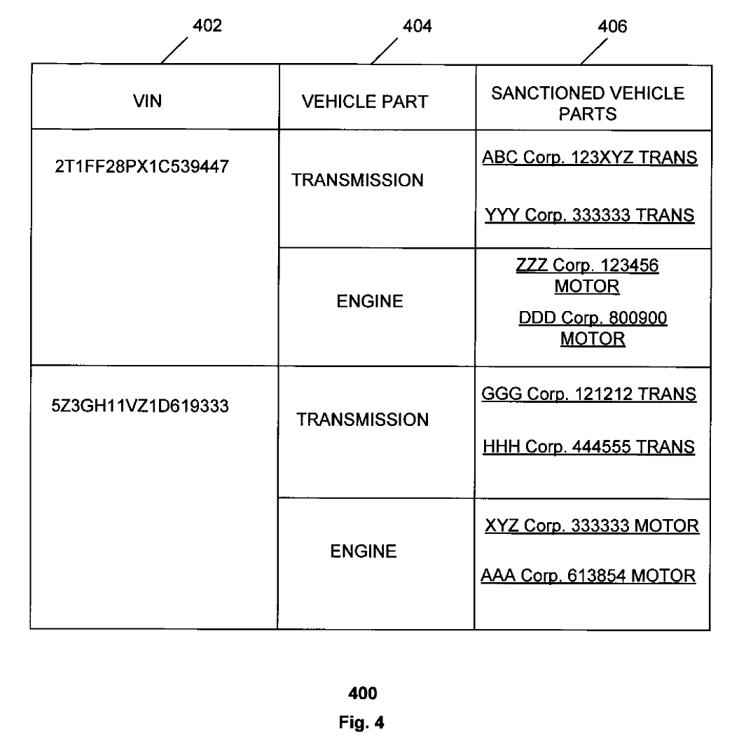

FIG. 5 provides an exemplary screen display 500 of login information according to at least one embodiment of the disclosure. As discussed above, an individual associated with a repair shop may interact with the procurement system using, for example, a web browser installed on a repair shop system to input and/or access information. By way of a non-limiting example, the login information display screen 500 may be arranged as depicted in FIG. 5.

As shown, the login information display screen 500 may include one or more data fields associated with the user's name 502, the user's account number 504, and/or a vehicle identification number 506. In various embodiments, when the user has input information into one, some, or all portions of the login information display screen 500, the user may submit the login information to the procurement system to activate a procurement session by activating (e.g., clicking on) a button 508 associated with submission. The user may also cancel the procurement session initiation and may return back at another time to complete the login information by activating a cancellation button 510.

In various embodiments, if the user submits incomplete login information, the procurement system may transmit an error message indicating the error to the repair shop system. Based on the login information submitted, the procurement system may initiate a procurement session by displaying one or more vehicle parts associated with the inputted VIN.

FIG. 6 provides another exemplary screen shot illustrating an exhaustive listing of possible choices for a part being sought, with a search initiated via part number, in the form of a cross-reference screen providing part numbers, descriptions, supplier codes and prices for the possible choices for a part number entry. The entire cross reference database contains over 425 million cross-references, along with a separate parts price database; these have been loaded into tables for access on the internet by both the procurement officer and the shop. Here, the user has searched for a WIX oil filter, part number 51515, and found 543 possible cross-references. The procurement officer, who has and acts as a specially authorized online user with the ability to choose and designate sanctioned parts, has already chosen the Freightliner ABP N10G LF3313 at a price of $2.65 to be the one for the shops to buy. The user in the shop (who represents an authorized end user, but one without the special authorization necessary to choose which parts will be sanctioned by the company) can click on any number in the cross-reference and post it to the e-procurement system as illustrated in FIG. 7.

In FIG. 7, a part number from the cross reference table provided in FIG. 3 has been posted into the e-procurement screen (called FLEETWATCH™) where possible choices are available. When the user clicks on the WIX Corporation as the source for the part, the said corporation appears (as illustrated in FIG. 8), but the Freightiner ABP N10G LF313 appears and is clearly designated as the preferred part.

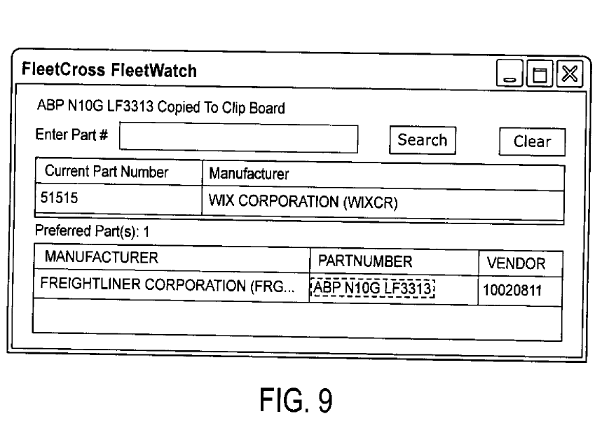

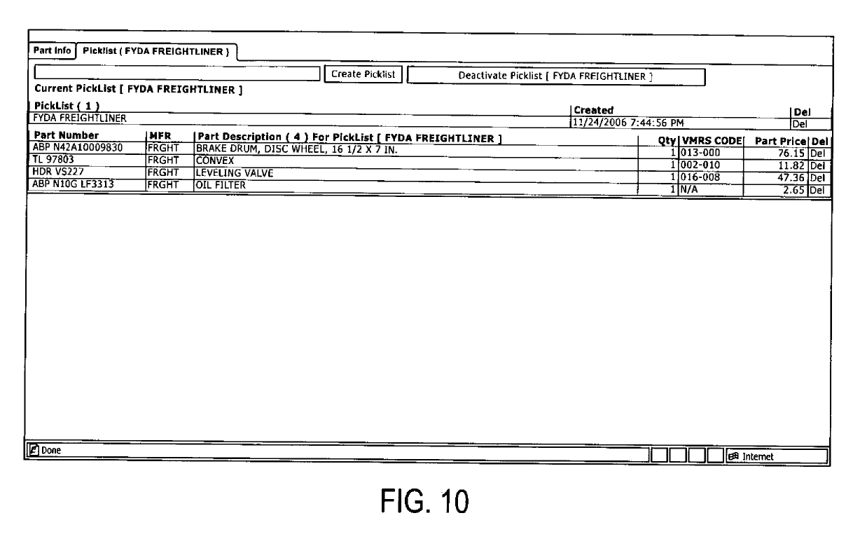

No matter what part number the user clicks on in the previous screen (FIG. 7), the sanctioned choice will be the only one that can be ordered, The user clicks on that number, bringing up the screen illustrated in FIG. 9, where (as illustrated at the top of the screen), the sanctioned part number has been copied to the purchase order. The purchase order screen, as illustrated in FIG. 10 is where all postings for a particular order are collected for forwarding to the dealer (FYDA FREIGHTLINER). The Freightliner oil filter ABP NI OG LF3 13 has been posted, along with its sanctioned price. The quantity can be edited by the user, but not the price or part number. (This ordering process can be integrated into other electronic systems or can operate as a stand-alone system.)

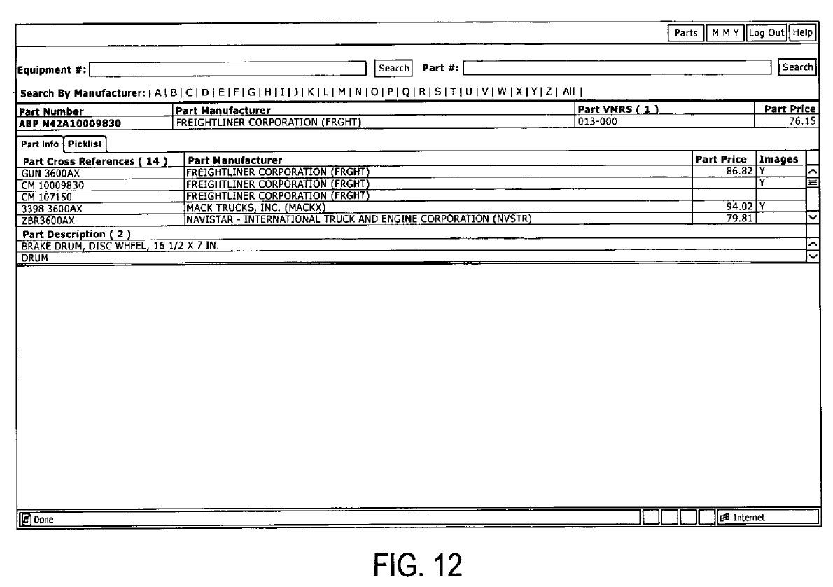

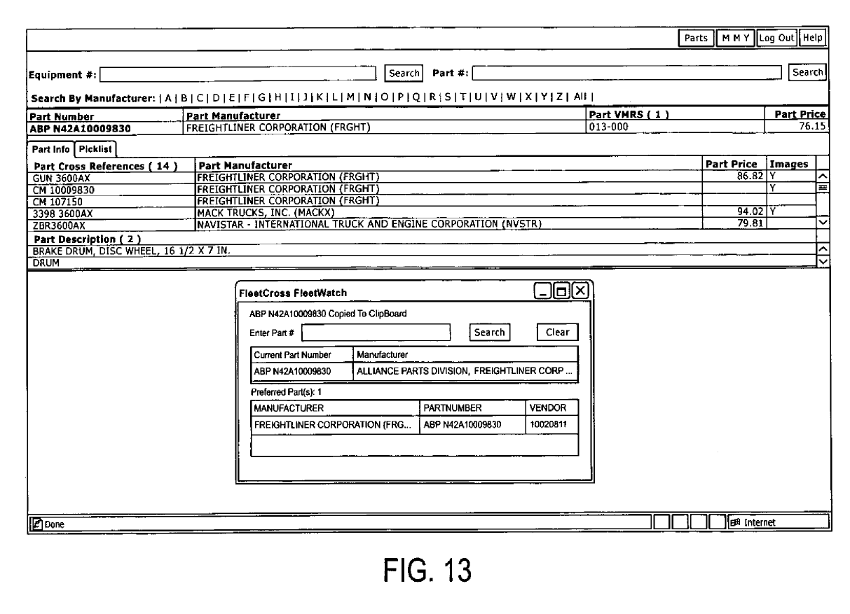

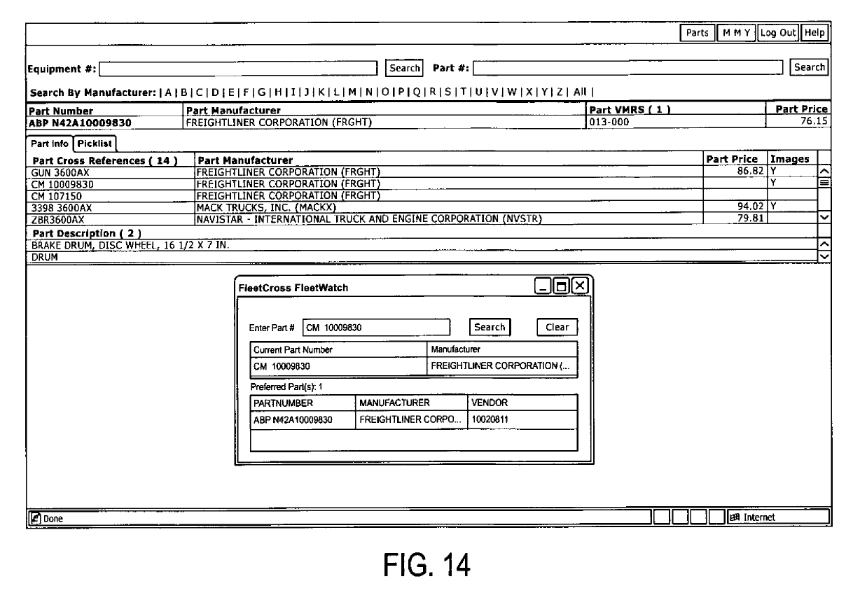

In the screen shown in FIG. 11, the user has used an alternative search initiator, entering a specific vehicle serial number (HV26291) and drilled down to the vehicle supplier part number for a brake drum (CM 10009830). The user then clicks on that number, bringing up the screen shown in FIG. 12. Here the cross-reference has automatically been opened to reveal that the CM 10009830 part number is not sanctioned, but that ABP N42A 10009830 is the sanctioned choice. The various part numbers, sources and prices shown in the cross-reference make it obvious why the number at the top is the sanctioned one. The user clicks on that number, leading to the screens shown in FIG. 13. The sanctioned part number and source have been electronically posted to the e-procurement screen. When clicked on, they are automatically copied to the purchase order. As illustrated in FIG. 14, if the user had clicked on the CM 10009839 part number in the cross-reference, the sanctioned part number would still be the only one to appear on the e-procurement screen for ordering,

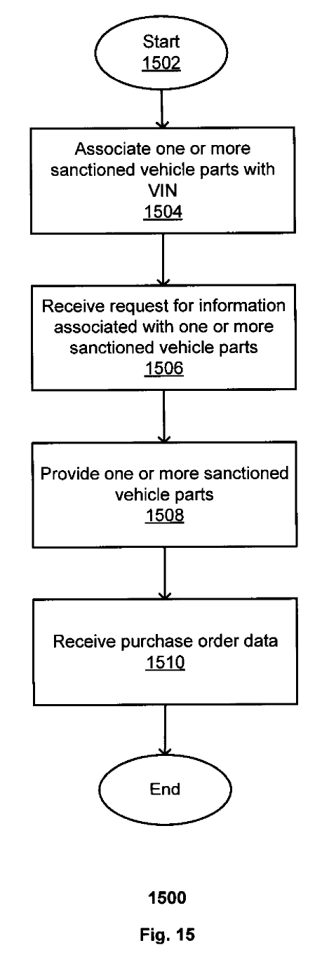

FIG. 15 provides a flow chart detailing a procurement system controlling procurement of sanctioned vehicle parts according to at least one embodiment of the disclosure. In block 1502, the method may be initiated. In block 1504, one or more sanctioned vehicle parts may be associated with a unique VIN. Sanctioned vehicle parts may include exact vehicle parts and/or alternative vehicle parts that are associated with pre-negotiated discount prices.

In block 1506, a procurement system may receive a VA and/or a request for information associated with one or more sanctioned vehicle parts associated with a specific vehicle. The specific vehicle may include a vehicle associated with a fleet company and/or a fleet. Based on the unique VIN, the procurement system may display one or more sanctioned vehicle parts associated with the VIN in block 1508.

In block 1508, a procurement system may output and/or display one or more sanctioned vehicle parts associated with the inputted VIN. In various embodiments, the procurement system may also output and/or display inventory data and/or pre-negotiated price data associated with the one or more sanctioned vehicle parts.

in block 1510, a procurement system may receive a purchase order associated with one or more sanctioned replacement vehicle parts and/or one or more non-sanctioned replacement vehicle parts. If one or more sanctioned replacement vehicle parts are requested in the purchase order in block 1510, the procurement system may transmit a purchase order to one or more parts supplier vendor systems and the method may end. In various embodiments, the procurement system may also transmit the purchase order to the associated fleet company system for record keeping purposes.

If, however, one or more sanctioned replacement vehicle parts are not requested in the purchase order received in block 1510, the procurement system may determine if one or more non-sanctioned replacement vehicle parts have been requested. If one or more non-sanctioned replacement vehicle parts are requested, the procurement system may transmit a non-sanctioned vehicle part notification to the associated fleet company. Procurement system may also transmit the purchase order to one or more parts supplier vendor system. In various embodiments, procurement system may be configured to wait for authorized from the associated fleet company system prior to transmitting the purchase order associated with non-sanctioned vehicle parts to one or more parts supplier vendor system and/or one or more parts supplier systems.

At least one exemplary embodiment may provide a method for placing and controlling electronic parts orders. This embodiment may include compiling an online database, said database including a listing of parts used in the assemblage of equipment and possible alternatives for each such part, and providing a computer program for accessing and processing information from the aforesaid database, the program enabling a specially authorized online user to access said database and designate which parts and alternatives are sanctioned for order, the program enabling an authorized online end user to search said database for a part and all alternatives for that part and indicating which said part or alternative is sanctioned for order, and the program enabling online ordering of a chosen part.

The end user may only order the sanctioned part. The program may enable a specially authorized user and an end user to determine all of the alternatives for a particular part and at least one of the prices, part numbers, and manufacturers therefore. A search of said database may be initiated by at least one of a part manufacturer's name, an equipment serial number, and a part number. The equipment may be a vehicle and said serial number may be a VIN. The online order may be automatically reported to the specially authorized online user. A single Code may be assigned and linked to each part, all alternatives for that part and all information related to that part.

Embodiments may also provide a method for placing and controlling electronic parts orders. These embodiments may include compiling an online database, said database including a listing of parts used in the assemblage of vehicles and possible alternatives for each such part, and providing a computer program for accessing and processing information from the aforesaid database, the program enabling a specially authorized online user to access said database and designate which parts and alternatives are sanctioned for order, the program enabling an authorized online end user to search said database for a part and all alternatives for that part and indicating which said part or alternative is sanctioned for order, and the program enabling online ordering only of a sanctioned part.

The program may enable a specially authorized user and an end user to determine all of the alternatives for a particular part and at least one of the prices, part numbers, and manufacturers therefore. A search of said database may be initiated by at least one of a part manufacturer's name, a vehicle identification number, and a part number. The online order may be automatically reported to the specially authorized online user. A single Code may be assigned and linked to each part, all alternatives for that part and all information related to that part.

Additional embodiments may provide a method for placing and controlling electronic parts orders. These embodiments may include compiling an online database, said database including a listing of parts used in the assemblage of vehicles and possible alternatives for each such part; providing a computer program for accessing and processing information from the aforesaid database, the program enabling a specially authorized online user to access said database and designate which parts and alternatives are sanctioned for order, the program enabling an authorized online end user to search said database for a part and all alternatives for that part and indicating which said part or alternative is sanctioned for order, and the program enabling online ordering only of a sanctioned part.

The program may enable a specially authorized user and an end user to determine all of the alternatives for a particular part and at least one of the prices, part numbers, and manufacturers therefore, A search of said database may be initiated S by at least one of a part manufacturer's name, a vehicle identification number, and a part number. The online order may be automatically reported to the specially authorized online user. A single Code may be assigned and linked to each part, all alternatives for that part and all information related to that part.

This method for placing and controlling electronic parts orders, requires the compiling of an online database that includes a listing of parts used in the assembly of vehicles (or other items of equipment) and possible alternatives for each such part. In addition, it requires the provision of a computer program for accessing and processing information from this database. The program enables a specially authorized online user such as a company procurement officer to access the database and designate which parts and alternatives are sanctioned for order. It also enables an authorized online end user such as a company shop to search the database for a part and all alternatives for that part while indicating which part or alternative is sanctioned for order. The program also enables online ordering of, in its preferred embodiment, only sanctioned parts.

However, it is to be understood that the inventive concepts underlying and embodied in my invention can be incorporated in different forms so that the general concepts described in the preceding description are not to be superseded by the particularity of the attached drawings. Various alterations, modifications, and/or additions can be made without departing from the spirit or ambit of the invention. Accordingly, it is to he understood that the embodiments of the invention herein described are merely illustrative of the application of the principles of the invention. Reference herein to details of the illustrated embodiments is not intended to limit the scope of the claims, which themselves recite those features regarded as essential to the invention.

The embodiments of the present inventions are not to be limited in scope by the specific embodiments described herein. Thus, modifications are intended to fall within the scope of the following appended claims. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A computer-implemented method for controlling procurement of sanctioned vehicle parts comprising:
associating one or more sanctioned vehicle parts with a specific vehicle in a fleet using a unique vehicle identification number;
receiving a request for information associated with one or more sanctioned vehicle parts for the specific vehicle; and
providing one or more sanctioned vehicle parts.

2. The method of claim 1, wherein receiving a request for information further comprises receiving the unique vehicle identification number.

3. The method of claim 1, wherein providing one or more sanctioned vehicle parts further comprises receiving a purchase order.

4. The method of claim 1, further comprising establishing a relationship with one or more repair shops, one or more fleet companies, and one or more pan supplier vendors.

5. The method of claim 1, wherein information associated with one or more sanctioned vehicle parts comprises vehicle part information.

6. The method of claim 1, further comprising receiving pre-negotiated price data.

7. The method of claim 6, wherein receiving pre-negotiated price data further comprises receiving pre-negotiated price data associated with one or more exact vehicle parts.

8. The method of claim 6, wherein receiving pre-negotiated price data further comprises receiving pre-negotiated price data associated with one or more alternative vehicle parts.

9. The method of claim 1, further comprising providing one or more non-sanctioned vehicle parts.

10. The method of claim 9, wherein one or more non-sanctioned vehicle parts comprises vehicles parts that are not associated with pre-negotiated price data.

11. A system for controlling procurement of sanctioned vehicle parts comprising;
a database module to associate one or more sanctioned vehicle parts with a specific vehicle in a fleet using a unique vehicle identification number;
a vehicle part module to receive a request for information associated with the one or more sanctioned vehicle parts for the specific vehicle; and
a purchase order module to provide one or more sanctioned vehicle parts.

12. The system of claim 11, wherein the vehicle part module is further configured to receive the unique vehicle identification number.

13. The system of claim 11, wherein the purchase order module is further configured to receive a purchase order.

14. The system of claim 11, wherein information associated with one or more sanctioned vehicle parts comprises vehicle part information.

15. The system of claim 11, wherein the database module is further configured to receive pre-negotiated price data.

16. The system of claim 15, wherein pre-negotiated price data is associated with one or more exact vehicle parts.

17. The system of claim 15, wherein pre-negotiated price data is associated with one or more alternative vehicle parts.

18. The system of claim 11, wherein the purchase order module is further configured to provide one or more non-sanctioned vehicle parts.

19. The system of claim 18, wherein one or more non-sanctioned vehicle parts comprises vehicle parts that are not associated with pre-negotiated price data.

20. A computer-implemented method for controlling procurement of sanctioned vehicle parts comprising:
establishing a relationship with one or more repair shops, one or more fleet companies, and one or more part supplier vendors;
associating one or more sanctioned vehicle parts with a specific vehicle in a fleet using a unique vehicle identification number;
receiving a request for information associated with one or more sanctioned vehicle parts for the specific vehicle; and
providing one or more sanctioned vehicle parts.
